(19) United States
(12) Patent Application Publication
(10) Pub. No.: US 2005/0190125 A1
(43) Pub. Date: Sep. 1, 2005

(54) Capacitive load driver and plasma display

(75) Inventors: Satoshi Ikeda, Suita-shi (JP); Yasuhiro Arai, Katano-shi (JP); Manabu Inoue, New Paltz, NY (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Matsushita Electric Industrial Co. Ltd.

(21) Appl. No.: 11/057,826

(22) Filed: Feb. 14, 2005

(30) Foreign Application Priority Data
Feb. 23, 2004 (JP) PAT. 2004-046457

(51) Int. Cl. G09G 3/28

(52) U.S. Cl. 345/70

(57) ABSTRACT

Pulse generating sections (1X, 1Y) convert a DC voltage (Vs) into voltage pulses (Vp), and apply the pulses to the sustain and scan electrodes (X, Y) of a PDP (20). Recovery switching devices (Q3X, Q4X, Q3Y, Q4Y) of power recovery sections (2X, 2Y) are turned on and off under the rising and falling edges of the voltage pulses (Vp), thereby connect recovery inductors (LpX, LpY) to recovery capacitors (CX, CY). Then, the recovery inductors (LpX, LpY) resonate with the panel capacitance (Cp). While the amounts of the resonance currents (ILX, ILY) are small, the inductances of the recovery inductors (LpX, LpY) are high. When the amounts of the resonance currents (ILX, ILY) exceed a threshold value, the inductances of the recovery inductors (LpX, LpY) are reduced.

### BACKGROUND OF THE INVENTION

The present invention relates to a driver for applying voltage pulses to a capacitive load (for example, a plasma display panel (PDP)), and in particular, relates to its power recovery section for regenerating the electric power required for the charging and discharging of the capacitive load at the application of the voltage pulses.

Plasma displays are display devices using luminescence caused by electric discharge in gas, and having the advantages in upsizing of screen, slimming-down, and widening of viewing angle over other display devices. The screen parts of plasma displays, that is, plasma display panels (PDP) are broadly divided into DC types, which are operated by DC pulses, and AC types, which are operated by AC pulses. The AC-type PDPs have, in particular, higher brightness and simpler structure. Accordingly, the AC-type PDPs are suitable for mass production and improvement in high definition, and thus, extensively used.

The AC-type PDP comprises, for example, a three-electrode surface-discharge structure. In that structure, address electrodes run vertically on the rear substrate of the PDP, and sustain and scan electrodes run alternately and horizontally on the front substrate of the PDP. Each of the address and scan electrodes, in general, allows an individual potential change. A discharge cell is installed at each intersection between the pair of the sustain and scan electrodes adjacent to each other and the address electrode. A layer consisting of dielectric material (a dielectric layer), a layer protecting the electrodes and the dielectric layer, and a layer including phosphor (a phosphor layer) are laminated on the surfaces of the discharge cell. Gas fills the inside of the discharge cell. Electric discharge takes place in the discharge cell when voltage pulses are applied between the sustain, and scan, and address electrodes. The electric discharge ionizes the gas molecules, and then, ultraviolet rays are emitted. The ultraviolet rays excite the phosphors on the surfaces of the discharge cell and cause them to emit fluorescence. Thus, the discharge cells emit visible light.

Subfield scheme is, in general, adopted as the display scheme of television images of plasma displays. One field is divided into two or more subfields under the subfield scheme. Each subfield includes an address period and a sustain period. During the address period, scan voltage pulses are applied to the scan electrodes in sequence. In synchronization with the application of the scan voltage pulses, data voltage pulses are applied to some address electrodes. Here, the address electrodes to which the data voltage pulses are to be applied are selected, with reference to the video signal received from the outside. When a scan voltage pulse is applied to one of the scan electrodes and a data voltage pulse is applied to one of the address electrodes, electric discharge takes place in the discharge cell located at the intersection of the scan and address electrodes. The electric discharge causes wall charges to accumulate on the surfaces of the discharge cell. During the sustain period, sustaining voltage pulses are applied to the sustain and scan electrodes alternately and periodically. In the discharge cell where the wall charges accumulate during the address period, the gas discharge and the accumulation of wall charges are repeated every time the polarity of the voltage between the sustain and scan electrodes is reversed. Accordingly, the light emission of the phosphors is sustained in the discharge cell. The duration of the sustain period varies from subfield to subfield, in general, and therefore, the light emission time per field of the discharge cell, namely, the luminosity of the discharge cell is adjusted by the selection of a subfield where the discharge cell should emit visible light.

Scan, data, and sustaining voltage pulses are each generated by individual pulse generating sections. Especially for the data voltage pulses, for example, target address electrodes and target subfields are determined with reference to the video signals. As a result, the images corresponding to the video signals are reproduced on the PDP.

In AC-type PDPs, the light emission of the discharge cells needs the accumulation of the wall charges. Thus, PDPs are capacitive loads, in general. Furthermore, in PDPs with structures such as the three-electrode surface-discharge type, many electrodes run on the panel vertically and horizontally and at close spacing. Accordingly, PDPs have large stray capacitances. In particular, the stray capacitance between sustain and scan electrodes (which is hereafter referred to as the panel capacitance) is large. When voltage pulses are applied to the sustain and scan electrodes of the PDP, the panel capacitance become charged and discharged. Owing to the charging and discharging currents, electric power is consumed at each resistance of circuit elements of the PDP driver, the sustain and scan electrodes of the PDP, and the lead wires. The power consumed does not contribute to light emission of the PDP, and in other words, it is reactive power. PDPs of larger size have longer and a larger number of sustain and scan electrodes, and accordingly, the panel capacitance is larger. Therefore, the reduction of the above-described reactive power is indispensable for the compatibility between screen upsizing and power reduction of the PDP.

For example, a conventional PDP driver including the following power recovery circuit is known as a PDP driver aimed at the reduction of the above-described reactive power. (See Published Japanese patent application S63-101897 gazette.) The power recovery circuit collects power required for the charging and discharging of the panel capacitance, when voltage pulses are applied to the PDP as follows. Furthermore, the collected power is reused for the charging and discharging of the panel capacitance at the applications of another voltage pulses. Thereby, the losses of the PDP during operation are reduced.

FIG. 14 is an equivalent circuit diagram of the above-described PDP driver 110 and the PDP 20. The PDP driver 110 comprises two quite similar power recovery sections 102X and 102Y and two quite similar pulse generating sections 1X and 1Y. The pulse generating sections 1X and 1Y constitute a full-bridge inverter, for example. In other words, the sections each include four main switching devices Q1X, Q2X, Q1Y, and Q2Y. The main switching devices Q1X, Q2X, Q1Y, and Q2Y are n-channel MOSFETs, for example. A DC voltage Vs is applied to the common input terminal I of the pulse generating sections 1X and 1Y. Hereafter, the input terminal I is referred to as a power supply terminal. The output terminals J1X and J1Y of the pulse generating sections 1X and 1Y are connected to the sustain electrodes X and the scan electrodes Y, respectively.

The equivalent circuit of the PDP 20 is represented only by the panel capacitance Cp and the paths of current flowing in the PDP 20 during the period of discharge in the discharge cells are omitted.

A first power recovery section 102X includes a first recovery capacitor CX, a first high side recovery switching device Q3X, a first low side recovery switching device Q4X, a first high side diode D1X, a first low side diode D2X, and a first recovery inductor LX. The two recovery switching devices Q3X and Q4X are, for example, n-channel MOSFETS. The source of the first high side recovery switching device Q3X is connected to the anode of the first high side diode D1X. The cathode of the first high side diode D1X is connected to the anode of the first low side diode D2X. The cathode of the first low side diode D2X is connected to the drain of the first low side recovery switching device Q4X. One end of the first recovery capacitor CX is grounded, and another end of it is connected to the drain of the first high side recovery switching device Q3X and the source of the first low side recovery switching device Q4X. One end of the first recovery inductor LX is connected to the output terminal J1X of the first pulse generating section 1X, and another end of the inductor is connected to the node J2X between the first high- and low-side diodes D1X and D2X. The circuitry of the second power recovery section 102Y is quite similar to the circuitry of the first power recovery section 102X except that one end of the second recovery inductor LY is connected to the output terminal J1Y of the second pulse generating section 1Y.

The recovery capacitors CX and CY each have sufficiently larger capacitance than the panel capacitance Cp of the PDP 20 has. Each voltage across the recovery capacitors CX and CY is maintained substantially equal to half value Vs/2 of the DC voltage Vs.

FIG. 15 is the graph which shows each DC superimposition characteristic of the recovery inductors LX and LY. In general, when a direct current is superimposed on a pulsing current to flow through the inductor, the inductance of the inductor changes in response to the amount of the superimposed direct current. However, in inductors used as the recovery inductors LX and LY, their inductances L hardly depend on superimposed direct currents Ib until their cores are saturated. (See FIG. 15.) Here, let Is be the amount of the superimposed direct current Ib when the core becomes saturated, which is hereafter referred to as a saturation current. The inductance L0 when the superimposed direct current Ib is equal to zero is substantially equal to the inductance Lm when the superimposed direct current Ib is substantially equal to half of the saturation current Is, which is hereafter referred to as an average current Im. (L0≈Lm) On the other hand, when the superimposed direct current Ib increases to the saturation current Is, inductances of the recovery inductors LX and LY abruptly drop.

In the pulse generating sections 1X and 1Y (cf. FIG. 14), the pair of the first high-side and the second low-side main switching devices Q1X and Q2Y, and the pair of the first low-side and the second high-side main switching devices Q2X and Q1Y are alternately turned on and off. Thereby, the polarity of the voltage Vp applied to the panel capacitance Cp is reversed at regular intervals. In other words, the AC voltage pulses Vp having a fixed period are applied to the panel capacitance Cp. At the rising and falling edges of the voltage pulse Vp, the panel capacitance Cp becomes charged and discharged. The recovery switching devices Q3X, Q4X, Q3Y, and Q4Y of the power recovery sections 102X and 102Y are turned on and off in synchronization with the rising and falling edges of the voltage pulses Vp. Thereby, either of the recovery inductors LX and LY is connected to the recovery capacitor CX or CY in the same power recovery section. At that time, that recovery inductor (LX or LY) resonates with the panel capacitance Cp. Here, the peaks of the resonance currents ILX and ILY is sufficiently lower than those of the saturation currents Is of the recovery inductors LX and LY. Owing to the resonance, electric power is efficiently exchanged between the recovery capacitor (CX or CY) and the panel capacitance Cp connected to each other. Accordingly, during the resonance, the electric power consumed in each resistance (not shown) of the circuit elements of the PDP driver 110, the sustain and scan electrodes X and Y of the PDP 20, and lead wires are suppressed. Thus, the reactive power caused by the charging and discharging of the panel capacitance Cp of the PDP 20 is reduced.

FIG. 16 is the waveform chart which shows changes in voltage/current at parts of the two pulse generating sections 1X and 1Y and the two power recovery sections 102X and 102Y. Eight control signals CTRL1X, CTRL2X, CTRL1Y, CTRL2Y, CTRL3X, CTRL4X, CTRL3Y, and CTRL4Y are sent to the respective gates of the four main switching devices Q1X, Q2X, Q1Y, and Q2Y and the four recovery switching devices Q3X, Q4X, Q3Y, and Q4Y. Each switching device is turned on and off according to the received control signal. In FIG. 16, when a control signal is changed to the high or low potential (is asserted or negated,) the corresponding switching device is turned on or off, respectively.

The switching operations of the pulse generating section 1X and 1Y and the power recovery sections 102X and 102Y are divided into the following four modes I-IV in each period of the voltage pulse Vp. (See FIG. 16.)

<Mode I>

At the start of the mode I, the potential VX of the sustain electrode X of the PDP 20 is substantially equal to zero, and the potential VY of the scan electrode Y is substantially equal to the potential Vs of the power supply terminal I. The first high-side and the second low-side recovery switching devices Q3X and Q4Y are turned on, and other switching devices are maintained in the OFF state. The switching brings into conduction the loop of a ground terminal the first recovery capacitor CX→the first high side recovery switching device Q3X→the first high side diode D1X→the first recovery inductor LX→the panel capacitance Cp→the second recovery inductor LY→the second low side diode D2Y→the second low side recovery switching device Q4Y→the second recovery capacitor CY→a ground terminal. (Here, the arrows indicate the direction of current. See FIG. 14.) At that time, the series circuit of the two recovery inductors LX and LY and the panel capacitance Cp undergo the application of the voltage Vs/2 from each of the two recovery capacitors CX and CY, and then resonate. The resonance current ILX=−ILY flows through the above-described loop in the direction of the arrows. Furthermore, the potential VX of the sustain electrode X rises and the potential VY of the scan electrode Y falls. Accordingly, the polarity of the voltage Vp=VX−VY across the panel capacitance Cp is reversed. When the resonance current ILX=−ILY declines substantially to zero, the first high-side and the second low-side diodes D1X and D2Y are turned off. At the same time, the voltage Vp across the panel capacitance Cp substantially reaches the positive peak Vs.

<Mode II>

The first high-side and the second low-side main switching devices Q1X and Q2Y are turned on, and the ON/OFF states of other switching devices are maintained. At that time, the potential VX of the sustain electrode X is maintained substantially equal to the potential Vs of the power supply terminal I, and the potential VY of the scan electrode Y is maintained substantially equal to the ground potential (≈0). Accordingly, the voltage Vp across the panel capacitance Cp is fixed at the level substantially equal to the positive peak Vs. Here, no switching losses occur at the first high-side and the second low-side main switching devices Q1X and Q2Y, since the voltages across them are substantially equal to zero. At the start of the mode II, electric discharge is maintained in the PDP 20 for a while. During the discharge period, the electric power to maintain the discharging current Ip is supplied through the power supply terminal I from the outside. (See the current I1X flowing through the first high side main switching device Q1X, shown in FIGS. 14 and 16.) When a predetermined time has elapsed from the start of the mode II, the first high-side and the second low-side recovery switching devices Q3X and Q4Y are first turned off. Next, the first high-side and the second low-side main switching devices Q1X and Q2Y are turned off. Here, no switching losses occur in the switching devices, since the voltages across them are substantially equal to zero.

<Mode III>

At the start of the mode III, the potential VX of the sustain electrode X is substantially equal to the potential Vs of the power supply terminal I, and the potential VY of the scan electrode Y is substantially equal to zero. The first low-side and the second high-side recovery switching devices Q4X and Q3Y are turned on, and other switching devices are maintained in the OFF state. The switching brings into conduction the loop of a ground terminal the first recovery capacitor CX the first low side recovery switching device Q4X←the first low side diode D2X←the first recovery inductor LX←the panel capacitance Cp←the second recovery inductor LY←the second high side diode D1Y←the second high side recovery switching device Q3Y←the second recovery capacitor CY←a ground terminal. (The arrows indicate the direction of current. See FIG. 14.) At that time, the series circuit of the two recovery inductors LX and LY and the panel capacitance Cp undergo the application of the voltage Vs/2 from each of the two recovery capacitors CX and CY, and then resonate. The resonance current −ILX=ILY flows through the above-described loop in the direction of the arrows. Furthermore, the potential VX of the sustain electrode X falls, and the potential VY of the scan electrode Y rises. Accordingly, the polarity of the voltage Vp=VX−VY of the panel capacitance Cp is reversed. When the resonance current −ILX=ILY declines substantially to zero, the first low-side and second high-side diodes D2X and D1Y are turned off. At the same time, the voltage Vp across the panel capacitance Cp substantially reaches the negative peak −Vs.

<Mode IV>

The first low-side and the second high-side main switching devices Q2X and Q1Y are turned on, and the ON/OFF states of other switching devices are maintained. At that time, the potential VX of the sustain electrode X is maintained substantially equal to the ground potential, and the potential VY of the scan electrode Y is maintained substantially equal to the potential Vs of the power supply terminal I. Accordingly, the voltage Vp across the panel capacitance Cp is fixed at the level substantially equal to the negative peak −Vs. Here, no switching losses occur in the first low-side and the second high-side main switching devices Q2X and Q1Y, since the voltages across them are substantially equal to zero. At the start of the mode IV, electric discharge is maintained in the PDP 20 for a while. During the discharge period, the electric power to maintain the discharging current Ip is supplied through the power supply terminal I from the outside. (See the current I1Y flowing through the second high side main switching device Q1Y, shown in FIGS. 14 and 16.) When a predetermined time has elapsed from the start of the mode IV, the first low-side and the second high-side recovery switching devices Q4X and Q3Y are first turned off. Next, the first low-side and the second high-side main switching devices Q2X and Q1Y are turned off. Here, no switching losses occur in the switching devices, since the voltages across them are substantially equal to zero. Thus, the conditions at the start of the mode I is reproduced.

The electric power supplied in the mode I from the first recovery capacitor CX to the panel capacitance Cp is recovered in the mode III from the panel capacitance Cp to the first recovery capacitor CX. Conversely, the electric power recovered in the mode I from the panel capacitance Cp to the second recovery capacitor CY is supplied in the mode III from the second recovery capacitor CY to the panel capacitance Cp. Thus, at the rising and falling edges of the voltage pulses, the recovery inductors resonate with the panel capacitance of the PDP, and thereby, electric power is efficiently exchanged between the recovery capacitors and the panel capacitance. In other words, at the application of the voltage pulses, the reactive power caused by the charging and discharging of the panel capacitance is reduced.

The following switching losses occur in conventional capacitive load drivers like the above-described PDP driver at the turn-on (a transition from the OFF state to the ON state) of the recovery switching devices. FIG. 17 is the enlarged waveform chart which shows the changes of the voltage V3X across the first high side recovery switching device Q3X and the resonance current ILX during the transient time from the mode IV to the mode I. (See FIG. 16.) In FIG. 17; the solid and broken lines indicate the resonance current ILX and the voltage V3X, respectively. In the transient time from the mode IV to the mode I, the first high side recovery switching device Q3X performs the turn-on operation under the condition with the voltage V3X to be sufficiently high. As a result, the waveform of the voltage V3X overlaps the waveform of the resonance current ILX. (See the hatched area shown in FIG. 17.) In the period when the overlap occurs, power loss (for example, heat dissipation) occurs in the first high side recovery switching device Q3X. Thus, switching losses occur. Similar switching losses occur in the second low side recovery switching device Q4Y during the transient time from the mode IV to the mode I, in the first low-side and the second high-side recovery switching devices Q4X and Q3Y during the transient time from the mode II to the mode III.

The switching losses at the turn-on of the recovery switching devices Q3X, Q4X, Q3Y, and Q4Y are undesirable since they reduce the recovery efficiency (the rate at which the recovered power is reused) of the power recovery sections 102X and 102Y. In order to reduce the switching losses, for example, the inductances of the recovery inductors LX and LY may be put to be high and the rising of the resonance currents ILX and ILY may be slowed down. On the other hand, the rising and falling of the voltage pulses will slow down since the resonance time, that is, the time required for power recovery will be extended. As a result, the maximum number of the pulses allowed to be applied across a capacitive load (for example, the PDP 20) within a fixed period will be reduced (as long as the peak of each voltage pulse is maintained high.)

The reduction of the above-described maximum number of pulses is, in particular, a problem in the PDP driver as follows. Further improvement in high image quality is required of PDPs. The improvement in high image quality needs higher brightness and a finer-step gradation of PDP. In the PDPs under the subfield scheme, more various subfield types per field allows the light emission time of discharge cell (in particular, the number of the sustaining voltage pulses) to be more precisely adjusted. In other words, the larger number of subfields per field can provide finer steps of gradation for PDPs. However, when the rising and falling of the voltage pulses are slow, the rise and fall time of the voltage pulses must be maintained long enough to maintain the high brightness of PDPs by maintaining the peaks of the voltage pulses high. As a result, it is difficult to further reduce address and sustain periods. Accordingly, it is difficult to further increase the number of subfields per field while the high brightness of PDP is maintained.

In order to raise the inductances of the recovery inductors while the time required for the power recovery (the resonance time of the recovery inductor and the capacitive load) is maintained short, the capacitance of the capacitive load and the peak of the resonance current may be reduced. However, especially in PDPs, it is difficult to further reduce the panel capacitances since the panel capacitances are determined by the panel structure and material.

### SUMMARY OF THE INVENTION

An object of the invention is to provide a driver of a capacitive load like PDP, which reduces switching losses caused by power recovery while maintaining the time required for power recovery short, thereby improving the recovery efficiency.

A capacitive load driver according to the invention comprising:

a pulse generating section which converts a DC voltage into voltage pulses and which applies the voltage pulses to a capacitive load;

and

a power recovery section including:
a recovery capacitor which has a capacitance larger than the capacitive load has and across which a substantially constant voltage is maintained;
a recovery inductor which resonates with the capacitive load and which has an inductance when passing a current substantially equal to zero, at least twice as high as the inductance when passing a current substantially equal to a predetermined threshold value; and
a recovery switching device connecting the recovery capacitor to or separating it from the capacitive load and the recovery inductor, thereby passing or interrupting the current caused by the resonance between the capacitive load and the recovery inductor.

The above-described capacitive load is preferably a plasma display panel (PDP). In that case, the above-described capacitive load driver according to the invention is installed in the following plasma display. The plasma display comprises:

a PDP comprising discharge cells emitting light owing to electric discharge in gas filling the discharge cells, and a plurality of electrodes for applying voltage pulses to the discharge cells;

a power supply section for converting an AC voltage from an external power supply to a DC voltage; and

a PDP driver for converting the DC voltage to voltage pulses. The above-described capacitive load driver according to the invention is used as the PDP driver.

In the above-described capacitive load driver according to the invention, in particular, the inductance of the recovery inductor with the current substantially equal to zero is at least twice as high as the inductance with the current substantially equal to a predetermined threshold value. The recovery inductor includes, for example, a partially saturable inductor having a partially saturable core. When the amount of the current flowing through the recovery inductor reaches the above-described threshold value, the core is partially saturated, and then, the inductance is reduced. Alternatively, the recovery inductor may be a combination of unsaturated and saturable inductors. When the amount of current flowing through the recovery inductor reaches the above-described threshold value, the core of the saturable inductor is saturated, and then, the inductance of the whole of the recovery inductor is reduced.

The switching losses at the turn-on of the recovery switching device are reduced owing to the above-described recovery inductor as follows: the recovery switching device starts turn-on operation and the voltage across it begins to fall, and at the same time, a resonance current begins to flow through the recovery inductor. The inductance of the recovery inductor is sufficiently high until the amount of current reaches the above-described threshold value, and accordingly, the amount of current increases at a sufficiently slow pace. In particular, the duration of the period when the amount of current increases slow is put to be longer than the turn-on time of the recovery switching device. Thereby, while the above-described amount of current is sufficiently small, the voltage across the recovery switching device falls substantially to zero. Thus, during the period when the waveforms of the voltage across the recovery switching device and the resonance current overlap each other, the inductance of the recovery inductor is maintained high and the resonance current is suppressed. Accordingly, the product of the voltage and the resonance current, that is, the switching loss is sufficiently suppressed. After the voltage across the recovery switching device falls substantially to zero, the resonance current exceeds the above-described threshold value. At that time, the inductance of the recovery inductor falls by a sufficiently large margin, and from then on, the change in resonance current is accelerated and the resonance proceeds fast. As a result, the whole of the resonance time, that is, the time required for the power recovery is maintained short.

Preferably in the above-described capacitive load driver according to the invention, the recovery switching device is maintained in the ON state during the rise or fall time of the above-described voltage pulse. Thereby, the recovery inductor resonates with the capacitive load during those periods. The resonance causes the power required for the charging and discharging of the capacitive load to be efficiently exchanged between the recovery capacitor and the capacitive load. In other words, the reactive power caused by the charging and discharging of the capacitive load is low.

In the above-described capacitive load driver according to the invention, preferably, the pulse generating section may include two main switching devices connected in series to each other; and the capacitive load and the recovery inductor may be connected to the node between the two main switching devices. In other words, the pulse generating section includes a switching inverter.

In the above-described capacitive load driver according to the invention, preferably, the power recovery section further comprises an auxiliary inductor magnetically coupled to the recovery inductor, and a current control section for controlling current flowing through the auxiliary inductor. The core of the recovery inductor is magnetized when a current flows through the auxiliary inductor. The magnetization changes the above-described threshold value. Accordingly, the duration from the time when the recovery switching device begins the turn-on operation until the amount of the resonance current flowing through the recovery inductor reaches the above-described threshold value, that is, the duration of the time when the inductance of the recovery inductor is maintained high, is adjusted in response to the amount of current of the auxiliary inductor. The adjustment allows the time when the resonance current reaches the above-described threshold value and the time when the inductance of the recovery inductor is reduced to coincide with the time when the voltage across the recovery switching device falls substantially to zero. As a result, the overall duration of the time when the recovery inductor resonates with the capacitive load, that is, the time required for the power recovery can be further shortened while the switching losses at the turn-on of the recovery switching device is sufficiently suppressed.

The above-described current control section preferably includes a variable current source connected to the auxiliary inductor. The variable current source preferably feeds current pulses through the auxiliary inductor before the turn-on of the recovery switching device. The variable current source may alternatively keep the current flowing through the auxiliary inductor during the operation of the pulse generating section or the recovery switching device.

The above-described current control section may include a protection diode that connects the node between the recovery inductor and the recovery switching device to the power supply terminal or the ground terminal, and the auxiliary inductor may be connected to the protection diode in series. When a surge voltage occurs at the node between the recovery inductor and the recovery switching device, the protection diode is brought into conduction, and then, a surge current flows through the auxiliary inductor.

The above-described current control section may include an impedance element that connects the output terminal of the pulse generating section to the recovery capacitor, and the auxiliary inductor may be connected to the impedance element in series. In that case, the voltage between the capacitive load and the recovery capacitor is applied to the series circuit of the impedance element and the auxiliary inductor. Accordingly, current keeps flowing through the auxiliary inductor during the operation of the pulse generating section or the recovery switching device.

In the above-described capacitive load driver according to the invention, the inductance of the recovery inductor is reduced with increase in current. Thereby, in contrast to conventional drivers, the switching losses at the turn-on of the recovery switching devices are effectively reduced, thus improving the recovery efficiency, maintaining the time required for the power recovery short. In other words, the above-described capacitive load driver according to the invention can sufficiently reduce the reactive power caused by the charging and discharging of the capacitive load, maintaining a large maximum number of pulses allowed to be applied to the capacitive load within a fixed period, in contrast to conventional drivers. Especially when the above-described capacitive load driver according to the invention is installed in a plasma display as its PDP driver, further screen upsizing and power saving of the PDP are both achievable while the high quality of the PDP is maintained.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a block diagram which shows a configuration of a plasma display according to Embodiment 1 of the invention;

FIG. 2 is a perspective view which shows the three-electrode surface-discharge structure of an AC-type PDP 20 according to Embodiment 1 of the invention;

FIG. 3 is an equivalent circuit diagram of sustain and scan electrode driver sections 11 and 12, and the PDP 20 according to Embodiment 1 of the invention;

FIG. 4 is a graph which shows each DC superimposition characteristic of recovery inductors LpX and LpY according to Embodiment 1 of the invention;

FIG. 5 is a perspective view which shows the structures of the recovery inductors LpX and LpY according to Embodiment 1 of the invention;

FIG. 6 is a waveform chart which shows the changes in voltage/current at parts of the sustain and scan electrode driver sections 11 and 12 according to Embodiment 1 of the invention;

FIG. 7 is an enlarged waveform chart which shows the changes of the voltage V3X across a first high side recovery switching device Q3X and a resonance current ILX in the mode I shown in FIG. 6;

FIG. 8 is an equivalent circuit diagram of sustain and scan electrode driver sections 11 and 12 and a PDP 20 according to Embodiment 2 of the invention;

FIG. 9 is a graph which shows each DC superimposition characteristic of recovery inductors LX+LsX and LY+LsY according to Embodiment 2 of the invention;

FIG. 10 is an equivalent circuit diagram of a sustain electrode driver section 11 and a PDP 20 according to Embodiment 3 of the invention;

FIG. 11 is an enlarged waveform chart which shows the changes of the voltage V3X across a first high side recovery switching device Q3X and a resonance current ILX in the mode I of the PDP driver according to Embodiment 3 of the invention;

FIG. 12 is an equivalent circuit diagram of a sustain electrode driver section 11 and a PDP 20 according to Embodiment 4 of the invention;

FIG. 13 is an equivalent circuit diagram of a sustain electrode driver section 11 and a PDP 20 according to Embodiment 5 of the invention;

FIG. 14 is an equivalent circuit diagram of the conventional PDP driver 110 and the PDP 20;

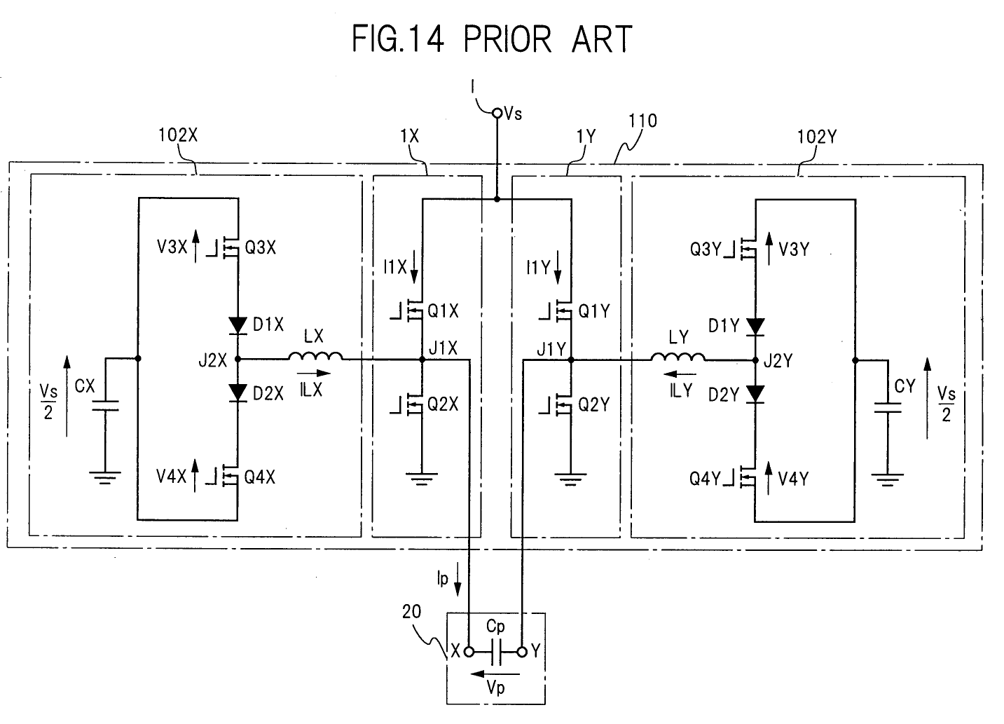

FIG. 15 is the graph which shows each DC superimposition characteristic of the conventional recovery inductors LX and LY;

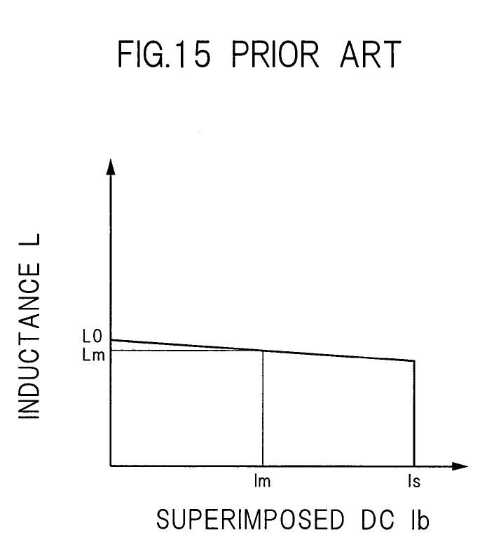

FIG. 16 is the waveform chart which shows the changes in voltage/current at parts of the conventional PDP driver 110;

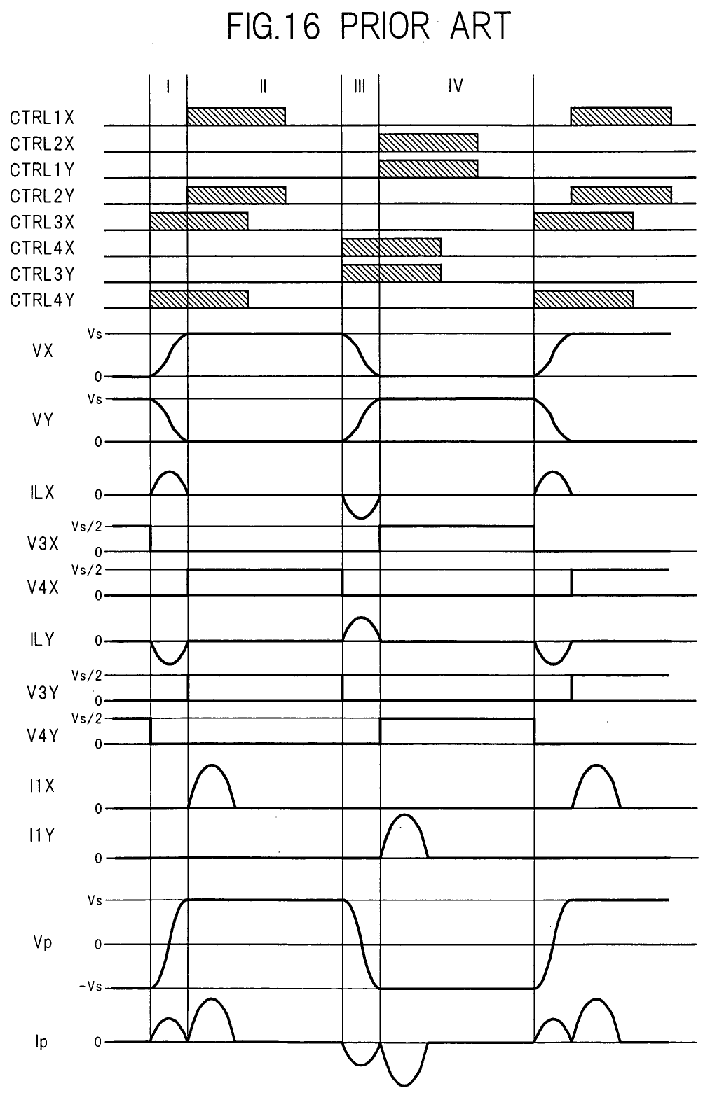

FIG. 17 is the enlarged waveform chart which shows the changes of the voltage V3X across the first high side recovery switching device Q3X and the resonance current ILX during the transition from the mode IV to the mode I shown in FIG. 16.

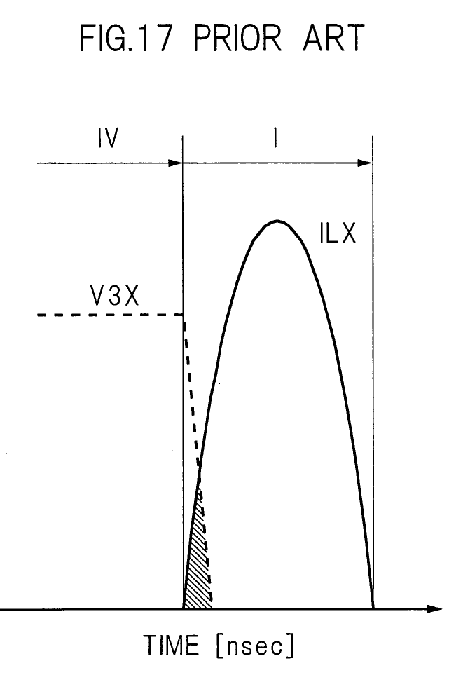

It will be recognized that some or all of the Figures are schematic representations for purposes of illustration and do not necessarily depict the actual relative sizes or locations of the elements shown.

### DETAILED DESCRIPTION OF THE INVENTION

The following explains the best embodiments of the present invention, referring to the figures.

### Embodiment 1

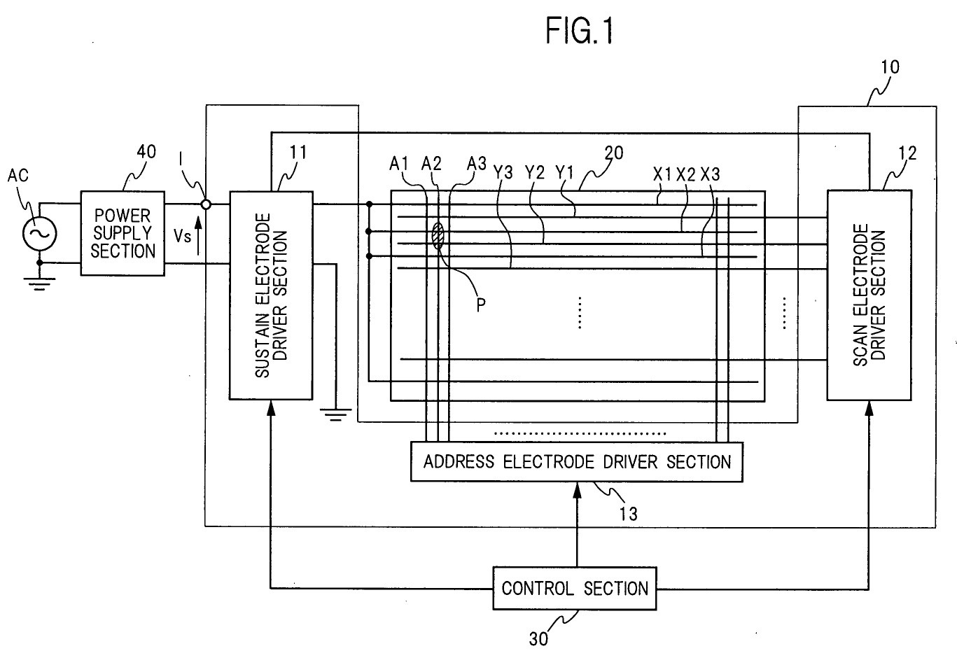

FIG. 1 is the block diagram which shows the configuration of a plasma display according to Embodiment 1 of the invention. The plasma display comprises a power supply section 40, a PDP 20, a PDP driver 10, and a control section 30.

The power supply section 40 converts AC power provided from the external commercial AC power supply AC to DC power, and supplies the DC power to the PDP driver 10. The power supply section 40, in particular, maintains its output voltage to the PDP driver 10 equal to a predetermined DC voltage Vs.

The PDP 20 is preferably an AC type and comprises the three-electrode surface-discharge structure. Address electrodes A1, A2, A3, . . . are arranged on the rear substrate of the PDP 20 in the vertical direction of the panel. Sustain electrodes X1, X2, X3, . . . and scan electrodes Y1, Y2, Y3, . . . are alternately arranged on the front substrate of the PDP 20 in the horizontal direction of the panel. The sustain electrodes X1, X2, X3, . . . are connected to each other, and thereby, have substantially the same potential. As for the address electrodes A1, A2, A3, . . . and the scan electrodes Y1, Y2, Y3, . . . , one each allows the individual potential change.

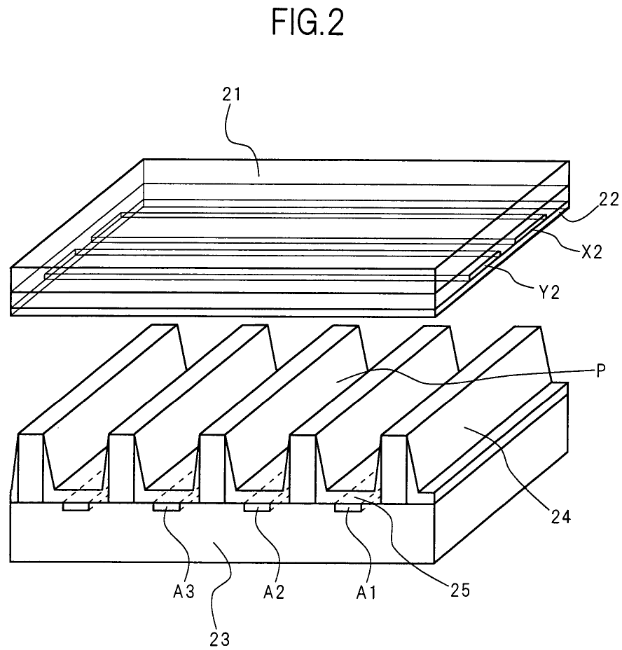

FIG. 2 is the perspective view which shows the three-electrode surface-discharge structure of the AC-type PDP 20. The front substrate 21 is made of glass. The sustain and scan electrodes X2 and Y2 are transparent electrodes. The insides of those electrodes X2 and Y2 are covered with dielectric and protective layers 22. The rear substrate 23 is made of glass. The address electrodes A1, A2, A3, . . . are embedded in the surface of the rear substrate 23. The partitions (ribs) 24 are formed in stripe shape over the address electrodes A1, A2, A3, . . . The surfaces of the partitions 24 are covered with phosphor layers 25. The gas is contained in the space (discharge cells) between the front and rear substrates 21 and 23 divided by the partitions 24. For example, predetermined voltage pulses are applied to the pair of the sustain and scan electrodes X2 and Y2 and the address electrode A2. At that time, in the discharge cell P located at the intersection of the electrodes (cf. the hatched area shown in FIGS. 1 and 2), electric discharge takes place, and thereby, gas molecules ionizes and emits ultraviolet rays. The ultraviolet rays excite phosphors in the phosphor layer 25 of the discharge cell P and cause them to create fluorescence. Thus, the discharge cell P emits visible light.

The PDP driver 10 includes a sustain electrode driver section 11, a scan electrode driver section 12, and an address electrode driver section 13. (See FIG. 1.) The input terminal I of the sustain electrode driver section 11 is connected to the power supply section 40. One output terminal of the sustain electrode driver section 11 is connected to the sustain electrodes X1, X2, X3, . . . of the PDP 20, and the other output terminal is grounded. The sustain electrode driver section 11 converts the DC voltage Vs applied from the power supply section 40 to voltage pulses, and applies them simultaneously to the sustain electrodes X1, X2, X3, . . . The input terminal of the scan electrode driver section 12 is connected to the power supply section 40 through the sustain electrode driver section 11. The output terminals of the scan electrode driver section 12 are connected to the respective scan electrodes Y1, Y2, Y3, . . . of the PDP 20. The scan electrode driver section 12 converts the DC voltage Vs applied from the power supply section 40 to voltage pulses, and applies them individually to the scan electrodes Y1, Y2, Y3, . . . The address electrode driver section 13 is connected to the address electrodes A1, A2, A3, . . . of the PDP 20. The address electrode driver section 13 generates data voltage pulses, and applies them to the electrodes selected from among the address electrodes A1, A2, A3, . . .

In the Japanese television broadcast, for example, each field of images is sent during an interval of 1/60 seconds (=about 16.7 msec). Thereby, the display time per field is fixed. On the other hand, the subfield scheme is, in general, adopted into plasma displays as a display scheme of television image. Under the scheme, each field is divided into two or more subfields. The subfield includes the following three periods in the order; a reset period, an address period, and a sustain period. Voltage pulses different among the three periods are applied to the PDP 20 as follows.

In the reset period, the reset voltage pulses are applied to the sustain electrodes X1, X2, X3, . . . and the scan electrodes Y1, Y2, Y3, . . . Thereby, wall charges are eliminated from the surfaces of all the discharge cells.

In the address period, the scan electrode driver section 12 applies the scan voltage pulses in turn to the scan electrodes Y1, Y2, Y3, . . . In synchronization with the application of the scan voltage pulses, the address electrode driver section 13 applies the data voltage pulses to the address electrodes A1, A2, A3, . . . Here, the address electrodes to which the data voltage pulses should be applied are selected, based on video signals entered from the outside. When the scan voltage pulse is applied to one of the scan electrodes and the data voltage pulse is applied to one of the address electrodes, electric discharge takes place in the discharge cell located at the intersection of the scan and address electrodes. The electric discharge causes wall charge to accumulate on the surfaces of the discharge cell.

In the sustain period, the sustain electrode driver section 11 applies sustaining voltage pulses to the sustain electrodes X1, X2, X3, . . . , and the scan electrode driver section 12 applies sustaining voltage pulses to the scan electrodes Y1, Y2, Y3, . . . The sustain and scan electrode driver sections 11 and 12 perform periodic operations in opposite phase. Thereby, the sustaining voltage pulses are applied alternately and periodically to the sustain and scan electrodes. At every reversal in polarity of the voltage between the sustain and scan electrodes, discharge in gas and accumulation of wall charge are repeated in the discharge cells where the wall charges accumulate during the address period. Accordingly, in the discharge cells, the light emission of the phosphors lasts during the sustain period.

The sustain, scan, and address electrode driver sections 11, 12, and 13 each include, preferably, a pulse generating section served as a switching inverter. The control section 30 performs switching control over those pulse generating sections. Thereby, the sustaining, scan, and data voltage pulses are generated in respective and predetermined waveform and timing. Preferably, the control section 30 determines the address electrodes to which data voltage pulses are to be applied, and the subfields in which data voltage pulses are to be applied, based on the video signals entered from the outside. As a result, the images corresponding to the video signals are reproduced on the PDP 20.

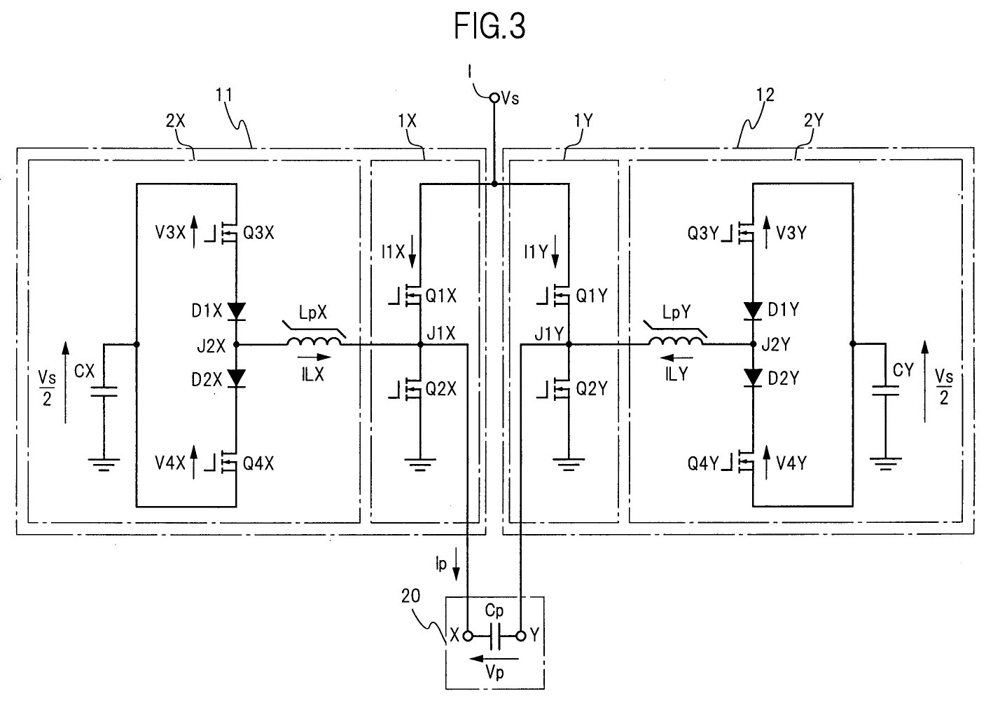

FIG. 3 is the equivalent circuit diagram of the sustain and scan electrode driver sections 11 and 12 and the PDP 20 in the sustain period. The sustain electrode driver section 11 comprises a first pulse generating section 1X and a first power recovery section 2X. The scan electrode driver section 12 comprises a second pulse generating section 1Y and a second power recovery section 2Y.

The first pulse generating section 1X is, preferably, a switching inverter including a series circuit of two main switching devices Q1X and Q2X. Similarly, the second pulse generating section 1Y is, preferably, a switching inverter including a series circuit of two main switching devices Q1Y and Q2Y. Those main switching devices Q1X, Q2X, Q1Y, and Q2Y are, preferably, n-channel MOSFETs. The power supply section 40 applies the DC voltage Vs to the common input terminal I of the pulse generating sections 1X and 1Y. Hereafter, the input terminal I is referred to as a power supply terminal. The output terminals J1X and J1Y of the pulse generating sections 1X and 1Y are connected to the sustain and scan electrodes X and Y of the PDP 20, respectively. Here, the equivalent circuit of the PDP 20 is represented only by a panel capacitance Cp, and paths of current flowing through the PDP 20 while electric discharges take place in the discharge cells are omitted.

The first power recovery section 2X includes a first recovery capacitor CX, a first high side recovery switching device Q3X, a first low side recovery switching device Q4X, a first high side diode D1X, a first low side diode D2X, and a first recovery inductor LpX. The two recovery switching devices Q3X and Q4X are, for example, n-channel MOSFETs. The source of the first high side recovery switching device Q3X is connected to the anode of the first high side diode D1X. The cathode of the first high side diode D1X is connected to the anode of the first low side diode D2X. The cathode of the first low side diode D2X is connected to the drain of the first low side recovery switching device Q4X. One end of the first recovery capacitor CX is grounded, and another end of it is connected to the drain of the first high side recovery switching device Q3X and the source of the first low side recovery switching device Q4X. The capacitance of the first recovery capacitor CX (about 1-100 micro farads) is sufficiently larger than the panel capacitance Cp of the PDP 20 (about 0.01-1 micro farads). The voltage across the first recovery capacitor CX is maintained substantially equal to the half value Vs/2 of the DC voltage Vs. One end of the first recovery inductor LpX is connected to the output terminal J1X of the first pulse generating section 1X, and another end of the inductor is connected to the node J2X between the first high- and low-side diodes D1X and D2X. The circuitry of the second power recovery section 2Y is quite similar to the circuitry of the first power recovery section 2X except that one end of the second recovery inductor LpY is connected to the output terminal J1Y of the second pulse generating section 1Y.

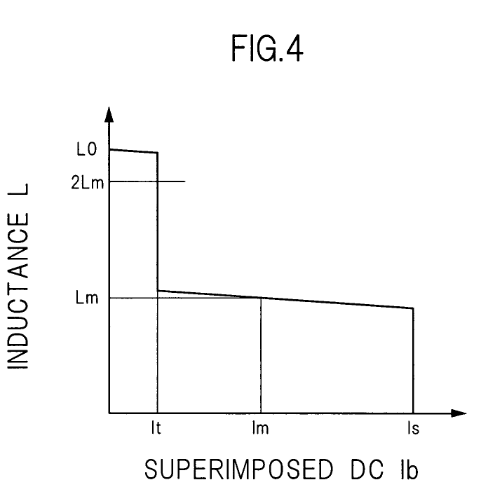

FIG. 4 is the graph which shows each DC superimposition characteristic of the recovery inductors LpX and LpY. The vertical and horizontal axes of FIG. 4 show the inductance L of the recovery inductors LpX and LpY, and the superimposed direct current Ib, respectively. The inductance L of the recovery inductors LpX and LpY depends on the superimposed direct current Ib, and changes as follows: (See FIG. 4.) When the superimposed direct current Ib is smaller than a predetermined threshold value It (which is hereafter referred to as a threshold current) (0<Ib <It), the inductance L is substantially equal to the inductance L0 when the superimposed direct current Ib is equal to zero (which is hereafter referred to as an initial inductance.) (L≈L0) When the superimposed direct current Ib is larger than the threshold current It and smaller than the saturation current Is (It<Ib<Is), the inductance L is substantially equal to the inductance Lm when the superimposed direct current Ib is substantially equal to half of the saturation current Is (which is hereafter referred to as a average inductance). (L≈Lm) Here, the initial inductance L0 is at least twice as high as the average inductance Lm (L0>2Lm.) When the superimposed direct currents Ib increases to the saturation current Is, the inductance L abruptly drops from the vicinity of the average inductance Lm close to zero.

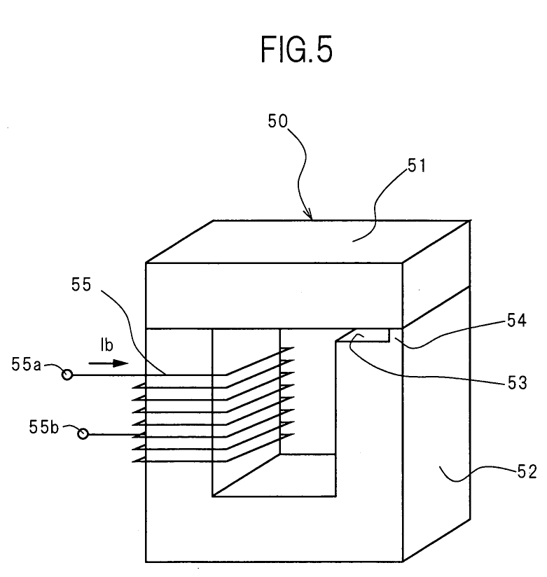

In Embodiment 1 of the invention, the recovery inductors LpX and LpY each have the following core allowing partial saturation to occur. Thereby, the DC superimposition characteristic shown in FIG. 4 is realized. FIG. 5 is the perspective view which shows the structure of the recovery inductor LpX or LpY. The core 50 is a combination of an I-shaped core member 51 and a U-shaped core member 52, which forms a closed magnetic circuit. A cut 53 is provided on the surface at the junction of the I-shaped core member 51 and one arm of the U-shaped core 52. In the vicinity of the cut 53, the gap of the two core members 51 and 52 is sufficiently limited, and the cross section of the core part 54 is small. A coil 55 is wound around the arm of the U-shaped core 52. One end 55a of the coil 55 is connected to the output terminal J1X (or J1Y) of the pulse generating section 1X (or 1Y), and another end 55b is connected to the node J2X (or J2Y) of the two diodes D1X and D2X (or, D1Y and D2Y.) (See FIG. 3.) When the current Ib flowing through the coil 55 is small, the magnetic fluxes are small inside the core 50. At that time, the inductances L of the recovery inductors LpX and LpY are substantially equal to the initial inductance L0. The magnetic fluxes inside the core 50 increase with the increase of the current Ib. When the current Ib reaches the threshold current It, the core part 54 around the cut 53 is saturated. Thereby, the inductance L suddenly drops close to the average inductance Lm. (See FIG. 4.) The magnetized state is hereafter referred to as a partial saturation state. When the current Ib exceeds the threshold current It and further increases, the additional magnetic fluxes pass through the gap in the cut 53. When the current Ib reaches the saturation current Is, all the members of the core 50 are saturated. Thereby, the inductance L abruptly drops from the vicinity of the average inductance Lm close to zero. (See FIG. 4.) The recovery inductors LpX and LpY may each have a core different from the above-described core, which has, for example, two circular core members concentrically stuck to each other. Here, one of the circular core members has a completely closed shape, and the other has a gap. Thereby, the cross sections are small at some parts of the closed magnetic circuit of the core, similarly to that of the core 50 shown in FIG. 5. Accordingly, the DC superimposition characteristic shown in FIG. 4 is realized.

The control section 30 (cf. FIG. 1) sends predetermined control signals to the gates of the main switching devices Q1X, Q2X, Q1Y, and Q2Y, and the recovery switching devices Q3X, Q4X, Q3Y and Q4Y, thereby controlling the turn-on and off of the switching devices as follows. The control section 30 turns on and off the pair of the first high-side and the second low-side main switching devices Q1X and Q2Y and the pair of the first low-side and the second high-side main switching devices Q2X and Q1Y alternately in a predetermined period (for example, several hundred kHz). Thereby, the polarity of the voltage Vp applied across the panel capacitance Cp is periodically reversed. In other words, the AC voltage pulses Vp with a fixed period are applied across the panel capacitance Cp. The control section 30 further turns on the first high-side and the second low-side recovery switching devices Q3X and Q4Y at the rising edge of the voltage pulse Vp, and turns on the first low-side and the second high-side recovery switching devices Q4X and Q3Y at the falling edge of the voltage pulse Vp. Thereby, the recovery inductors LpX and LpY are connected to the recovery capacitors CX and CY, and resonate with the panel capacitance Cp owing to each voltage Vs/2 across the recovery capacitors CX and CY.

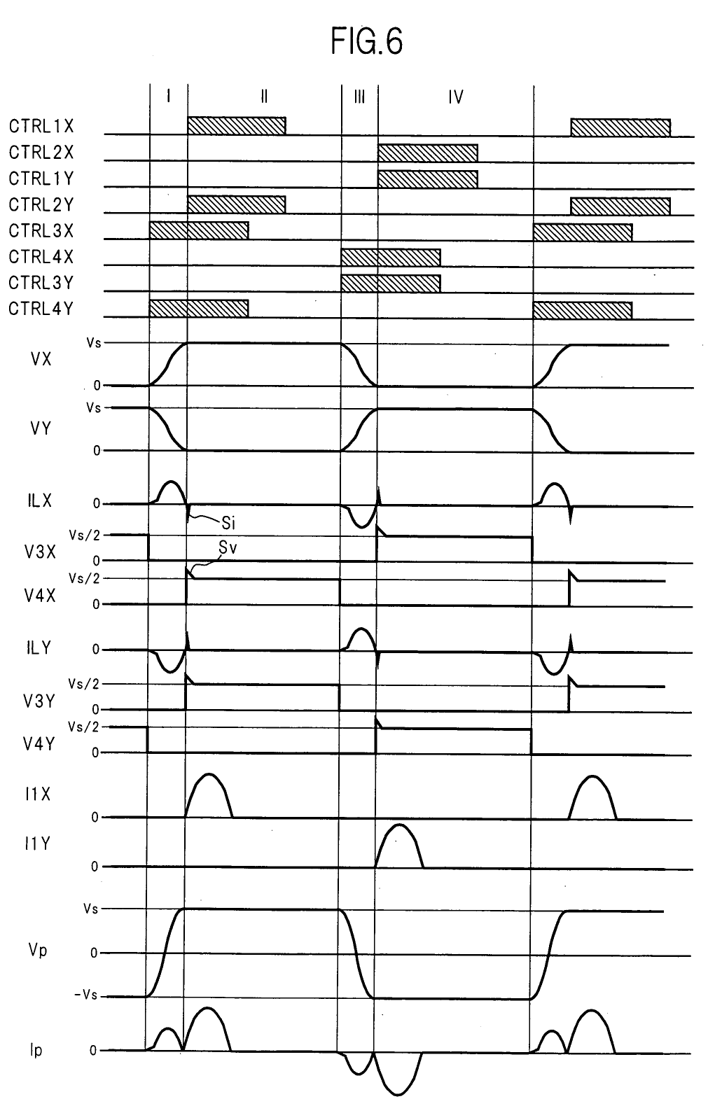

FIG. 6 is the waveform chart which shows changes in voltage/current at parts of the pulse generating sections 1X and 1Y and the power recovery sections 2X and 2Y. Let CTRL1X, CTRL2X, CTRL1Y, CTRL2Y, CTRL3X, CTRL4X, CTRL3Y, and CTRL4Y be eight control signals which the control section 30 sends to the gates of the main switching devices Q1X, Q2X, Q1Y, and Q2Y and the recovery switching devices Q3X, Q4X, Q3Y, and Q4Y, respectively. Each switching device is turned on and off in accordance with the received control signal. In FIG. 6, when a control signal is asserted or negated, the corresponding switching device is turned on or off, respectively.

The switching operations of the pulse generating sections 1X and 1Y and the power recovery sections 2X and 2Y are divided into the following four modes I-IV in each period of the voltage pulse Vp. (See FIG. 6.)

<Mode I>

At the start of the mode I, the potential VX of the sustain electrode X of the PDP 20 is substantially equal to zero and the potential VY of the scan electrode Y is substantially equal to the potential Vs of the power supply terminal I. The control section 30 asserts the control signals CTRL3X and CTRL4Y. Thereby, the first high-side and the second low-side recovery switching devices Q3X and Q4Y are turned on. On the other hand, other switching devices are maintained in the OFF state. The switching brings into conduction the loop of a ground terminal the first recovery capacitor CX→the first high side recovery switching device Q3X→the first high side diode D1X→the first recovery inductor LpX→the panel capacitance Cp→the second recovery inductor LpY→the second low side diode D2Y→the second low side recovery switching device Q4Y→the second recovery capacitor CY→a ground terminal. (The arrows indicate the direction of current. See FIG. 3.) At that time, the series circuit of the two recovery inductors LpX and LpY and the panel capacitance Cp resonates owing to the voltage Vs/2 applied from each of the two recovery capacitors CX and CY. The resonance current ILX=−ILY flows through the above-described loop in the direction of the arrows.

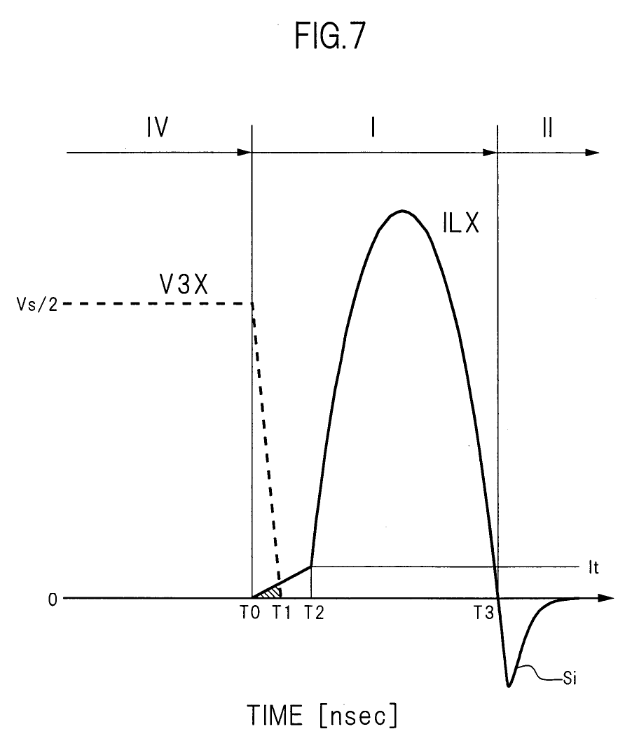

FIG. 7 is the enlarged waveform chart which shows the changes of the voltage V3X across the first high side recovery switching device Q3X and the resonance current ILX in a series of the modes IV, I, and II. (See FIG. 6.) In FIG. 7, the solid and broken lines show the resonance current ILX and the voltage V3X, respectively. The first high-side and the second low-side recovery switching devices Q3X and Q4Y start the turn-on operation from the time T0 when the mode I starts. Thereby, both the voltages V3X and V4Y begin to fall from the peak value Vs/2. At the same time, the resonance current ILX=−ILY begins to flow through the recovery inductors LpX and LpY. At the time T1, the recovery switching devices Q3X and Q4Y finish the turn-on operation, and both the voltage V3X and V4Y fall from the peak value Vs/2 substantially to zero. At the time T2, the resonance current ILX=−ILY reaches the threshold current It, and then, the cores of the recovery inductors LpX and LpY change state into partial saturation.

During the period T0-T2, each inductance L of the recovery inductors LpX and LpY is substantially equal to the initial inductance L0 and sufficiently high, and thus, the increase of the resonance current ILX=−ILY is sufficiently slow. (See FIG. 4.) In particular, the duration T2-T0 of the period is put longer than the turn-on time T1 -T0 of the recovery switching devices Q3X and Q4Y. Thereby, while the resonance current ILX=−ILY is sufficiently small, both of the voltages V3X and V4Y of the recovery switching devices Q3X and Q4Y fall substantially to zero. Accordingly, the product of the voltage and the resonance current, that is, the switching loss is sufficiently small during the period T0-T1 in which the waveforms of the voltages V3X and V4Y of the recovery switching devices Q3X and Q4Y overlap the waveform of the resonance current ILX=−ILY. (See the hatched area shown in FIG. 7.)

After the time T2, the cores of the recovery inductors LpX and LpY are maintained in the partial saturation state, and accordingly, each inductance L of the recovery inductors LpX and LpY is reduced to the average inductance Lm. (See FIG. 4.) Accordingly, the change of the resonance current ILX=−ILY is accelerated, and thereby, the resonance progresses fast. At the time T3, the resonance current ILX=−ILY declines substantially to zero. Thus, the switching losses at the turn-on of the recovery switching devices Q3X and Q4Y are reduced, while the overall duration T3-T0 of the mode I, or the duration of the time required for the power recovery is maintained short.

In the mode I, furthermore, the potential VX of the sustain electrode X rises and the potential VY of the scan electrode Y falls. (See FIG. 6.) Accordingly, the polarity of the voltage Vp=VX−VY across the panel capacitance Cp is reversed. At the time T3, the resonance current ILX=−ILY declines substantially to zero, and then, the first high-side and the second low-side diodes D1X and D2Y are turned off. (See FIG. 3.) At the same time, the voltage Vp across the panel capacitance Cp reaches substantially to the positive peak Vs.

<Mode II>

At the start of the mode II, surge voltages Sv occur at the node J2X between the diodes D1X and D2X and at the node 2Y between the diodes D1Y and D2Y (see FIG. 6), and surge currents Si flow through the recovery inductors LpX and LpY (see FIG. 7.) The control section 30 asserts the control signals CTRL1X and CTRL2Y. (See FIG. 6.) Thereby, the first high-side and the second low-side main switching devices Q1X and Q2Y are turned on. (See FIG. 3.) On the other hand, the control section 30 maintains the ON and OFF states of other switching devices. At that time, the potential VX of the sustain electrode X is clamped to the potential Vs of the power supply terminal I, and the potential VY of the scan electrode Y is clamped to the ground potential. Accordingly, the voltage Vp across the panel capacitance Cp is fixed substantially equal to the positive peak Vs. Here, at the first high-side and the second low-side main switching devices Q1X and Q2Y, the voltage across each of them is substantially equal to zero, and therefore, no switching losses occur.

From the start of the mode II, electric discharge is sustained in the PDP 20 for awhile. During the discharge period, the electric power for maintaining the discharging current Ip is supplied to the PDP 20 through the power supply terminal I from the outside. (See the current I1X flowing through the first high side main switching device Q1X shown in FIGS. 3 and 6.) When a predetermined time has elapsed from the start of the mode II, the control section 30 first negates the control signals CTRL3X and CTRL4Y. Thereby, the first high-side and the second low-side recovery switching devices Q3X and Q4Y are turned off. The control section 30 next negates the control signals CTRL1X and CTRL2Y. Thereby, the first high-side and the second low-side main switching devices Q1X and Q2Y are turned off. Here, at those switching devices, the voltage across them is substantially equal to zero, and therefore, no switching losses occur.

<Mode III>

At the start of the mode III, the potential VX of the sustain electrode X is substantially equal to the potential Vs of the power supply terminal I and the potential VY of the scan electrode Y is substantially equal to zero. The control section 30 asserts the control signals CTRL4X and CTRL3Y. Thereby, the first low-side and the second high-side recovery switching devices Q4X and Q3Y are turned on. On the other hand, other switching devices are maintained in the OFF state. The switching brings into conduction the loop of the ground terminal←the first recovery capacitor CX←the first low side recovery switching device Q4X←the first low side diode D2X←the first recovery inductor LpX←the panel capacitance Cp←the second recovery inductor LpY←the second high side diode D1Y←the second high side recovery switching device Q3Y←the second recovery capacitor CY←the ground terminal. (The arrows indicate the direction of current. See FIG. 3.) At that time, the series circuit of the two recovery inductors LpX and LpY and the panel capacitance Cp resonates owing to the voltage Vs/2 applied from each of the two recovery capacitors CX and CY. The resonance current −ILX=ILY flows through the above-described loop in the direction of the arrows.

The first low-side and the second high-side recovery switching devices Q4X and Q3Y start the turn-on operation, and thereby, both the voltages V4X and V3Y across them begin to fall from the peak value Vs/2. At the same time, the resonance current −ILX=ILY begins to flow through the recovery inductors LpX and LpY in the direction opposite to that in the mode I. Thereby, the cores of the recovery inductors LpX and LpY promptly escape from the partial saturation state. Accordingly, each inductance L of the recovery inductors LpX and LpY is substantially equal to the initial inductance L0 and sufficiently high after the start of the mode III until the resonance current −ILX=ILY reaches the threshold current It again. (See FIG. 4.) Therefore, the increase of the resonance current −ILX=ILY is sufficiently slow during the period. Here, the duration of the period is put longer than the turn-on time of the two recovery switching devices Q4X and Q3Y. Thereby, while the resonance current −ILX=ILY is sufficiently small, the voltages V4X and V3Y across the recovery switching devices Q4X and Q3Y, respectively, fall substantially to zero. Accordingly, in the period when the waveform of the voltages V4X and V3Y across the recovery switching devices Q4X and Q3Y, respectively, overlap the waveform of the resonance current −ILX=ILY, the product of the voltages and the resonance current, or the switching loss is sufficiently low. After that, when the resonance current −ILX=ILY increases to the threshold current It, the cores of the recovery inductors LpX and LpY change state into the partial saturation again. Thereby, the inductances L of the recovery inductors LpX and LpY are reduced to the average inductance Lm. (See FIG. 4.) Accordingly, from then on, the change of the resonance current −ILX=ILY is accelerated and the resonance progresses fast. Thus, the switching losses at the turn-on of the recovery switching devices Q4X and Q3Y are reduced while the overall duration of the mode III, or the time required for the power recovery is maintained short. Furthermore, in the mode III, the potential VX of the sustain electrode X falls and the potential VY of the scan electrode Y rises. Accordingly, the polarity of the voltage Vp=VX−VY across the panel capacitance Cp is reversed. When the resonance current −ILX=ILY declines substantially to zero, the first low-side and the second high-side diodes D2X and D1Y are turned off. (See FIG. 3.) At the same time, the voltage Vp across the panel capacitance Cp reaches substantially to the negative peak −Vs.

<Mode IV>

At the start of the mode IV, surge voltages Sv occur at the node J2X between the diodes D1X and D2X and the node 2Y between the diodes D1Y and D2Y (cf. FIG. 6), and surge currents Si flow through the recovery inductors LpX and LpY (cf. FIG. 7.) The control section 30 asserts the control signals CTRL2X and CTRL1Y. (See FIG. 6.) Thereby, the first low-side and the second high-side main switching devices Q2X and Q1Y are turned on. (See FIG. 3.) On the other hand, the control section 30 maintains the ON and OFF states of other switching devices. At that time, the potential VX of the sustain electrode X is clamped to the ground potential, and the potential VY of the scan electrode Y is clamped to the potential Vs of the power supply terminal I. Accordingly, the voltage Vp across the panel capacitance Cp is fixed substantially equal to the negative peak −Vs. Here, in the first low-side and the second high-side main switching devices Q2X and Q1Y, the voltages across them are substantially equal to zero, and then, no switching losses occur. Electric discharge is maintained in the PDP 20 from the start of the mode IV for a while. In the discharge period, the electric power to maintain a discharging current Ip is supplied to the PDP 20 through the power supply terminal I from the outside. (See the current I1Y flowing through the second high side main switching device Q1Y shown in FIGS. 3 and 6.) When a predetermined time has elapsed from the starting moment of the mode IV, the control section 30 first negates the control signals CTRL4X and CTRL3Y. Thereby, the first low-side and the second high-side recovery switching devices Q4X and Q3Y are turned off. The control section 30 next negates the control signals CTRL2X and CTRL1Y. Thereby, the first low-side and the second high-side main switching devices Q2X and Q1Y are turned off. Here, the voltage signals are substantially equal to zero, and then, no switching losses occur in the switching devices. Thus, the conditions at the start of the mode I are reproduced.

In the mode I, the electric power supplied from the first recovery capacitor CX to the panel capacitance Cp is recovered in the mode III from the panel capacitance Cp to the first recovery capacitor CX. In the mode I, conversely, the electric power recovered from the panel capacitance Cp to the second recovery capacitor CY is supplied in the mode III from the second recovery capacitors CY to the panel capacitance Cp. Thus, the recovery inductor resonates with the panel capacitance of the PDP, and the electric power is efficiently exchanged between the recovery capacitor and the panel capacitance at the rising and falling edges of the voltage pulses. In other words, at the application of the voltage pulses, reactive power caused by the charging and discharging of the panel capacitance is reduced.

At each start of the modes I and III, the inductances L of the recovery inductors LpX and LpY are maintained high, and then, the resonance currents ILX and ILY are small during the period when the waveforms of the voltages V3X, V4X, V3Y, and V4Y of the recovery switching devices Q3X, Q4X, Q3Y, and Q4Y, respectively, overlap the waveforms of the resonance currents ILX, ILY. Accordingly, the product of the voltage and the resonance current, that is, no switching losses are sufficiently suppressed. Furthermore, after the voltages V3X, V4X, V3Y, and V4Y across the recovery switching devices Q3X, Q4X, Q3Y, and Q4Y, respectively, fall substantially to zero, the resonance currents ILX and ILY exceed the threshold current. At that time, the cores of the recovery inductors LpX and LpY change state in the partial saturation. Accordingly, from then on, a resonance progresses fast since the inductances L of the recovery inductors ILX and ILY are reduced. Thus, the switching losses at the turn-on of the recovery switching devices Q3X, Q4X, Q3Y, and Q4Y are maintained short, while the time required for the power recovery is maintained short.

### Embodiment 2

A plasma display and its PDP driver according to Embodiment 2 of the invention comprise configurations quite similar to those of the plasma display and the PDP driver according to the above-described Embodiment 1, respectively. For the details of the similar configurations, the description of Embodiment 1 and FIGS. 1 and 2 are cited.

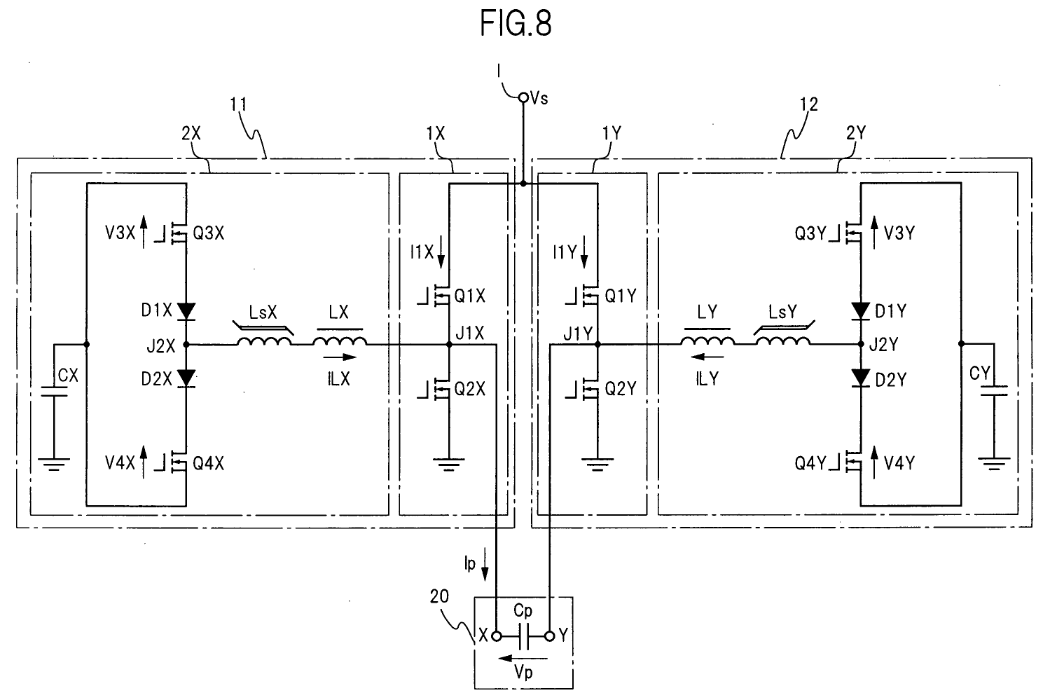

FIG. 8 is the equivalent circuit diagram of a sustain electrode driver section 11, a scan electrode driver section 12, and a PDP 20 according to Embodiment 2 of the invention. Each recovery inductor includes an unsaturated inductor LX or LY and a saturable inductor LsX or LsY in the driver sections 11 and 12, in contrast to the driver sections 11 and 12 according to Embodiment 1 of the invention (cf. FIG. 3.) Other components are similar to the components according to Embodiment 1. In FIG. 8, the similar components are marked with the same reference symbols as the reference symbols shown in FIG. 3. Furthermore, for the details of the similar components, the description of Embodiment 1 is cited.

A first recovery inductor is a series connection LX+LsX of a first unsaturated inductor LX and a first saturable inductor LsX. One end of the first recovery inductor LX+LsX is connected to the output terminal J1X of the first pulse generating section 1X, and another end of the inductor is connected to the node J2X between the first high- and low-side diodes D1X and D2X. A second recovery inductor is a series connection LY+LsY of a second unsaturated inductor LY and a second saturable inductor LsY. One end of the second recovery inductor LY+LsY is connected to the output terminal J1Y of the second pulse generating section 1Y, and another end of the inductor is connected to the node J2Y between the second high- and low-side diodes D1Y and D2Y.

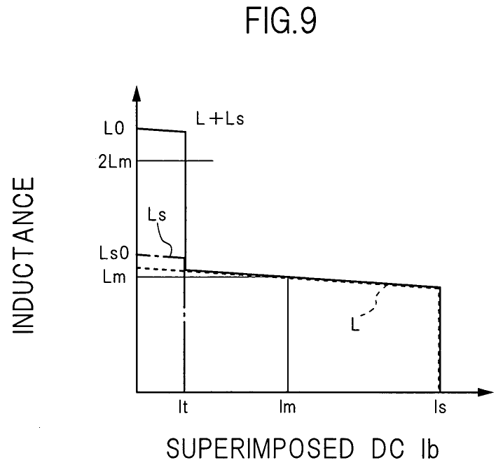

FIG. 9 is the graph which shows each DC superimposition characteristic of the recovery inductors LX+LsX and LY+LsY. The vertical and horizontal axes of FIG. 9 show the inductance and the superimposed direct current Ib, respectively. In FIG. 9, the broken line, the alternate long and short dash line, and the solid line show the inductance L of the unsaturated inductors LX and LY, the inductance Ls of the saturable inductors LsX and LsY, and the sum L+Ls of both inductances, respectively. In the unsaturated inductors LX and LY, the inductance L hardly depends on the superimposed direct current Ib until the core is saturated. (See the broken line of FIG. 9.) The inductance L is, in particular, substantially equal to an average inductance Lm (the inductance when the superimposed direct current Ib is substantially equal to half of the saturation current Is (or, an average current Im=Ib/2)). (L≈Lm) When the superimposed direct current Ib increases to the saturation current Is, the inductance L abruptly drops substantially to zero. The cores of the saturable inductors LsX and LsY become saturated earlier than the cores of the unsaturated inductors LX and LY. Thereby, each inductance L of the acceptable saturation inductors LsX and LsY, depending on the superimposed direct current Ib, changes as follows (cf. the alternate long and short dash line of FIG. 9): When the superimposed direct current Ib is smaller than the threshold current It (0<Ib<It), the inductance Ls is substantially equal to the initial inductance Ls0. (Ls≈Ls0) Here, the initial inductance Ls0 is at least equal to the average inductance Lm of the unsaturated inductors LX and LY. (Ls0>Lm) When the superimposed direct current Ib reaches the threshold current It (Ib≈It), the core changes state into saturation, and accordingly, the inductance Ls abruptly drops from the vicinity of the initial inductance Ls0 close to zero. Here, the threshold current It is smaller than the average current Im. (It<Im) As a result of the above-described, each inductance L+Ls of the recovery inductors LX+LsX and LY+LsY, depending on the superimposed direct current Ib, changes as follows (cf. the solid line of FIG. 9): When the superimposed direct current Ib is smaller than the threshold current It (0<Ib<It), the inductance L+Ls is substantially equal to the initial inductance L0≈Lm+Ls0. Here, the initial inductance L0 is at least twice as high as the average inductance Lm. (L0>2Lm) When the superimposed direct current Ib is larger than the threshold current It and smaller than the saturation current Is (It<Ib<Is), the inductance L+Ls is substantially equal to the average inductance Lm. (L+Ls≈Lm) When the superimposed direct current Ib increases to the saturation current Is, the inductance L+Ls abruptly drops from the vicinity of the average inductance Lm close to zero.

Each DC superimposition characteristic of the recovery inductors LX+LsX and LY+LsY according to Embodiment 2 of the invention, as it is shown in the solid line of FIG. 9, agrees with the DC superimposition characteristic shown in FIG. 4. Accordingly, the switching losses at the turn-on of the recovery switching devices Q3X, Q4X, Q3Y, and Q4Y are reduced while the time required for the power recovery is maintained short, similarly to the PDP driver according to Embodiment 1 of the invention.

The saturable inductors LsX and LsY preferably comprise amorphous cores. In that case, the direct current superimposition characteristic shown in the alternate long and short dash line of FIG. 9 (in particular, the following two properties) is easily realized: “When the superimposed direct current Ib reaches the threshold current It, the inductance Ls abruptly drops,” and “When the superimposed direct current Ib exceeds the threshold current It, the inductance Ls is maintained sufficiently low.”

### Embodiment 3

A plasma display and a PDP driver according to Embodiment 3 of the invention comprise quite similar configurations of the plasma display and the PDP driver according to the above-described Embodiment 2, respectively. For the details of the similar configurations, the description of Embodiments 1 and 2 and FIGS. 1-9 are cited.

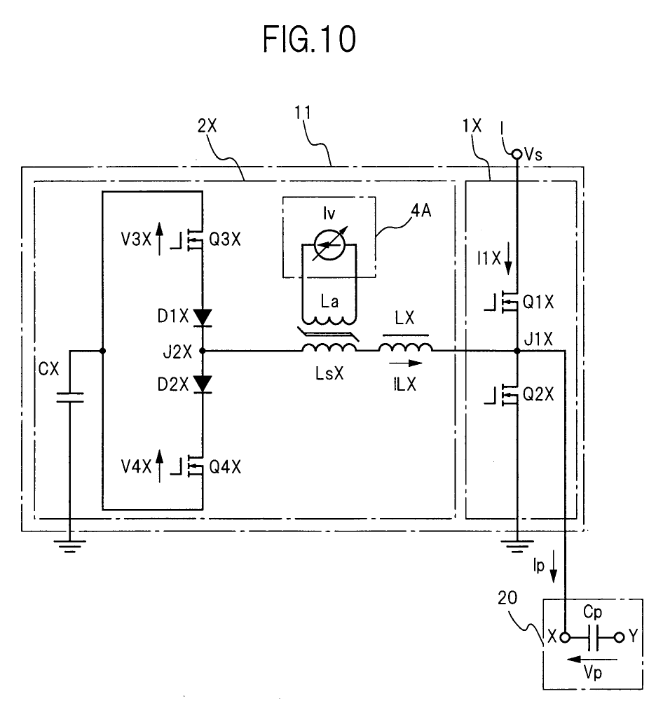

FIG. 10 is the equivalent circuit diagram of a sustain electrode driver section 11 and a PDP 20 according to Embodiment 3 of the invention. Here, the circuitry of the scan electrode driver section 12 is quite similar to the circuitry of the sustain electrode driver section 11, and thus, the equivalent circuit of the scan electrode driver section 12 is omitted. The sustain and scan electrode driver sections 11 and 12 according to Embodiment 3 of the invention include an auxiliary inductor La and a current control section 4A, in addition to the components of the driver sections 11 and 12 according to Embodiment 2 of the invention. (See FIG. 8.) Other components are similar to the components according to Embodiment 2. In FIG. 10, the similar components are marked with the same reference symbols as the reference symbols shown in FIG. 8. Furthermore, for the details of the similar components, the description of Embodiments 1 and 2 are cited.

The auxiliary inductor La is magnetically coupled to the saturable inductor LsX. When the saturable inductor LsX includes a core and a winding, the auxiliary inductor La preferably includes another winding wound around the core shared with the saturable inductor LsX. The current control section 4A includes a variable current source Iv. The variable current source Iv is connected to the auxiliary inductor La and controls current to flow through the auxiliary inductor La. The variable current source Iv preferably feeds current pulses through the auxiliary inductor La before each turn-on of the recovery switching devices Q3X and Q4X, or before each start of the modes I and III (cf. FIG. 6). Alternatively, the variable current source Iv may keep current flowing through the auxiliary inductor La during the switching operation of the first pulse generating section 1X or the recovery switching devices Q3X and Q4X, or throughout the modes I-IV (cf. FIG. 6.) Here, the level and timing of the current to flow through the auxiliary inductor La are preferably controlled in accordance with the control signal sent from the control section 30 (cf. FIG. 1.)

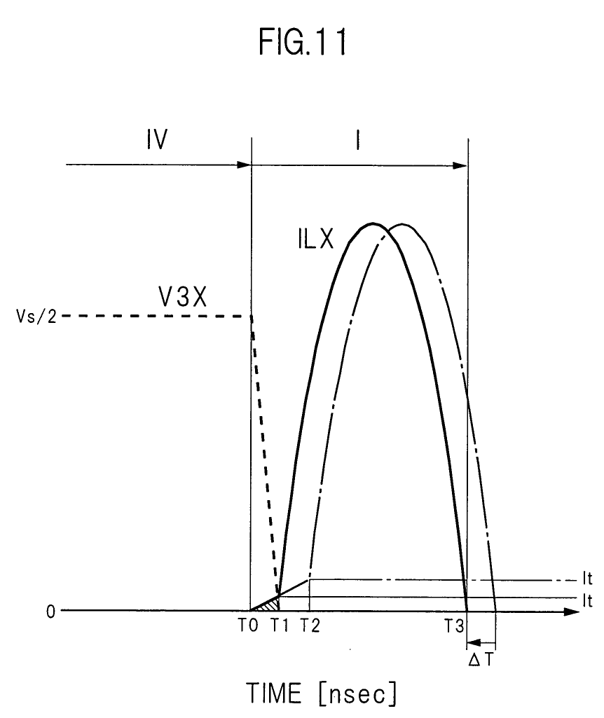

The passage of current through the auxiliary inductor La with the above-described timing causes the core of the saturable inductor LsX to be magnetized before the mode I or III. Owing to the magnetization, the threshold current It of the saturable inductor LsX changes, and accordingly, the resonance current ILX changes in the modes I and III as follows. In FIG. 11, the alternate long and short dash line indicates the resonance current ILX when the core of the saturable inductor LsX is not magnetized, and the solid line indicates the resonance current ILX when the core of the saturable inductor LsX is magnetized in advance.

When the core of the saturable inductor LsX is magnetized in advance, the threshold current It is reduced for the current flowing through the winding so that the magnetic field is created in the direction of the magnetization. (See FIG. 11.) The quantity reduced at that time is adjusted using the magnetization of the core of the saturable inductor LsX, that is, the amount of current to flow in advance through the auxiliary inductor La. In particular, the time T2 when the resonance current ILX reaches the threshold current It can be coincident with the time T1 when the voltage V3X (or V4X) across the recovery switching device Q3X (or Q4X) substantially reaches zero. (See the solid line shown in FIG. 11.) In other words, right after the overlap in waveform between the voltage V3X (or V4X) across the recovery switching device Q3X (or Q4X) and the resonance current ILX becomes dissolved, the inductance of the recovery inductor LX+LsX is reduced, and then, the change of the resonance current ILX is accelerated. As a result, the overall duration T3-T0 of the mode I (or III) is shortened while the switching loss at the turn-on of the recovery switching device Q3X (or Q4X) is sufficiently suppressed. (See ΔT shown in FIG. 11.)

Preferably, the current amount of the variable current source is adjusted separately for each actual PDP driver, further for the individual sustain and scan electrode driver sections. Thereby, the threshold current can be optimized to be appropriate to the actual magnetization characteristic of the saturable inductor, and therefore, the PDP driver according to Embodiment 3 of the invention can maintain the high reliability.

### Embodiment 4

A plasma display and a PDP driver according to Embodiment 4 of the invention comprise quite similar configurations of the plasma display and the PDP driver according to the above-described Embodiment 2, respectively. For the details of the similar configurations, the description of Embodiments 1 and 2 and FIGS. 1-9 are cited.

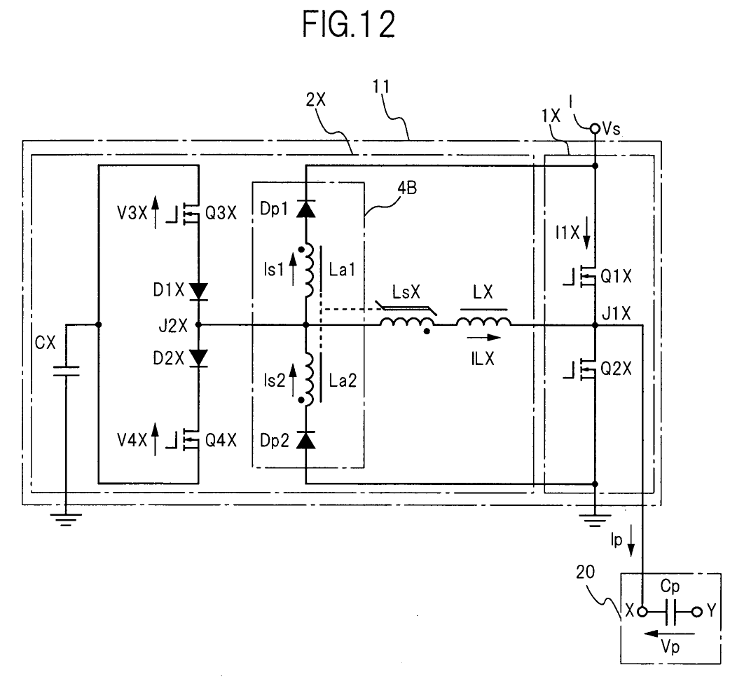

FIG. 12 is the equivalent circuit diagram of a sustain electrode driver section 11 and a PDP 20 according to Embodiment 4 of the invention. Here, the circuitry of the scan electrode driver section 12 is quite similar to the circuitry of the sustain electrode driver section 11, and thus, the equivalent circuit of the scan electrode driver section 12 is omitted. The sustain and scan electrode driver sections 11 and 12 according to Embodiment 4 of the invention include two auxiliary inductors La1 and La2 and a current control section 4B, in addition to the components of the driver sections 11 and 12 according to Embodiment 2 of the invention (cf. FIG. 8.) Other components are similar to the components according to Embodiment 2. In FIG. 12, the similar components are marked with the same reference symbols as the reference symbols shown in FIG. 8. Furthermore, for the details of the similar components, the description of Embodiments 1 and 2 are cited.

Both the auxiliary inductors La1 and La2 are magnetically coupled to the saturable inductor LsX. The polarities of the magnetic coupling are opposite to each other between the two auxiliary inductors La1 and La2. When the saturable inductor LsX includes a core and a winding, the auxiliary inductors La1 and La2 preferably include another winding wound around the core shared with the saturable inductor LsX. In that case, the polarity of the windings of the auxiliary inductors La1 and La2 are opposite to each other.

The current control section 4B preferably includes two protection diodes Dp1 and Dp2. The high side protection diode Dp1 is connected in series to the high side auxiliary inductor La1, and the low side protection diode Dp2 is connected in series to the low side auxiliary inductor La2. The series connections Dp1+La1 and Dp2+La2 of the protection diode and the auxiliary inductor are inserted between the power supply terminal I and the node J2X of the two diodes D1X and D2X, and between the node J2X and a ground terminal, respectively. The high side protection diode Dp1 cuts off the current −Is1 to flow from the power supply terminal I to the node J2X, and the low side protection diode Dp2 cuts off the current −Is2 to flow from the node J2X to the power supply terminal I.

During the sustain period, at the node J2X between the saturable inductor LsX and the diodes D1X and D2X, actually, a positive surge voltage Sv occurs right after the mode I, and an negative surge voltage Sv occurs right after the mode III. (See FIG. 6.) Right after the mode I, at the moment when the potential of the node J2X exceeds the potential Vs of the power supply terminal I, the high side protection diode Dp1 is brought into conduction, and then, the potential of the node J2X is clamped to the potential Vs of the power supply terminal I. Furthermore, the surge current Is1 flows from the node J2X through the series connection of the high side protection diode Dp1 and the high side auxiliary inductor La1 to the power supply terminal I. Thereby, the core of the saturable inductor LsX escapes from the saturation state, and further, becomes magnetized in the opposite direction. Right after the mode III, at the moment when the potential of the node J2X falls below the ground potential, the low side protection diode Dp2 is brought into conduction, and then, the potential of the node J2X is clamped to the ground potential. Furthermore, the surge current Is2 flows from the ground terminal through the series connection of the low side protection diode Dp2 and the low side auxiliary inductor La2 to the node J2X. Thereby, the core of the saturable inductor LsX escapes from the saturation state, and further, becomes magnetized in the opposite direction.

The potential of the node J2X falls within the range from the ground potential to the potential Vs of the power supply terminal I owing to the clamping function of the protection diodes Dp1 and Dp2. Accordingly, the recovery switching devices Q3X and Q4X are in particular protected from overvoltage. Furthermore, the current Is1 flows through the high side auxiliary inductor La1 right after the mode I, and thereby, the core of the saturable inductor LsX is magnetized before the following mode III. Similarly, the current Is2 flows through the low side auxiliary inductor La2 right after the mode III, and thereby, the core of the saturable inductor LsX is magnetized before the following mode I. The magnetizations reduce the threshold current It of the saturable inductor LsX, and accordingly, the voltage V3X (or V4X) of the recovery switching device Q3X (or Q4X) can substantially reach zero upon the resonance current ILX reaching the threshold current It, similarly to Embodiment 3. (See FIG. 11.) As a result, the overall duration of the mode I (or III) is shortened while the switching loss at the turn-on of the recovery switching device Q3X (or Q4X) is sufficiently suppressed. (See ΔT shown in FIG. 11.)

### Embodiment 5

A plasma display and a PDP driver according to Embodiment 5 of the invention comprise quite similar configurations of the plasma display and the PDP driver according to the above-described Embodiment 2, respectively. For the details of the similar configurations, the description of Embodiments 1 and 2 and FIGS. 1-9 are cited.

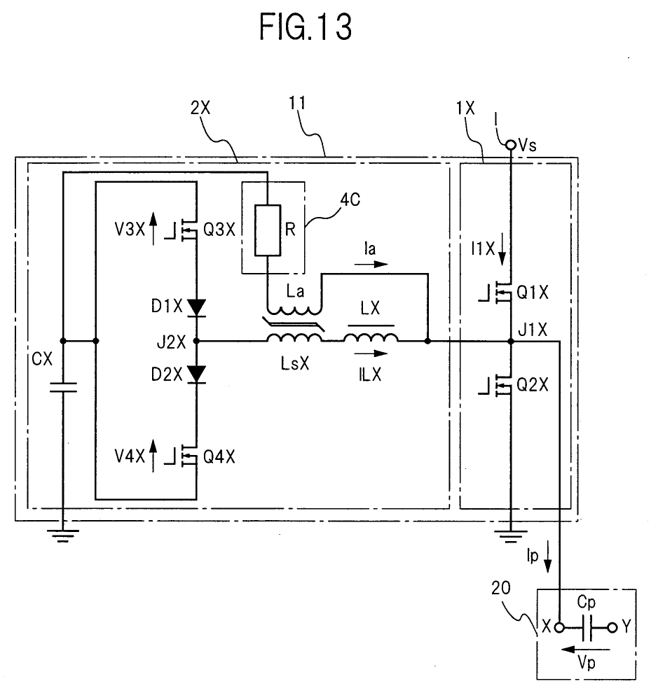

FIG. 13 is the equivalent circuit diagram of a sustain electrode driver section 11 and a PDP 20 according to Embodiment 5 of the invention. Here, the circuitry of the scan electrode driver section 12 is quite similar to the circuitry of the sustain electrode driver section 11, and accordingly, the equivalent circuit of the scan electrode driver section 12 is omitted. The sustain and scan electrode driver sections 11 and 12 according to Embodiment 5 of the invention include an auxiliary inductor La and a current control section 4C in addition to the components of the driver sections 11 and 12 according to Embodiment 2 of the invention (cf. FIG. 8.) Other components are similar to the components according to Embodiment 2. In FIG. 13, the similar components are marked with the same reference symbols as the reference symbols shown in FIG. 8. Furthermore, for the details of the similar components, the description of Embodiments 1 and 2 are cited.

The auxiliary inductor La is magnetically coupled to the saturable inductor LsX. When the saturable inductor LsX includes a core and a winding, the auxiliary inductor La preferably includes another winding wound around the core shared with the saturable inductor LsX.

The current control section 4C includes an impedance element R. The impedance element R is preferably a resistor. Alternatively, it may be a capacitor. The impedance element R is connected in series to the auxiliary inductor La, and inserted between the first recovery capacitor CX and the output terminal J1X of the first pulse generating section 1X.

During the sustain period, the potential of the output terminal J1X of the first pulse generating section 1X, that is, the potential VX of the sustain electrode X of the PDP 20 fluctuates at the voltage Vs/2 across the first recovery capacitor CX. (See FIG. 6.) In the mode II, the potential VX=Vs of the sustain electrode X is maintained higher than the voltage Vs/2 across the first recovery capacitor CX, and accordingly, the current −Ia flows from the sustain electrode X through the series connection of the auxiliary inductor La and the impedance element R to the first recovery capacitor CX. Thereby, the core of the saturable inductor LsX escapes from the saturation state, and further, becomes magnetized in the opposite direction. In the mode IV, the potential VX=0 of the sustain electrode X is maintained lower than the voltage Vs/2 across the first recovery capacitor CX, and accordingly, the current Ia flows from the recovery capacitor CX through the series connection of the impedance element R and the auxiliary inductor La to the sustain electrode X. Thereby, the core of the saturable inductor LsX escapes from the saturation state, and further, becomes magnetized in the opposite direction. Thus, the core of the saturable inductor LsX is magnetized before the modes I and III, and therefore, the threshold current It of the saturable inductor LsX is reduced. Accordingly, the voltage V3X (or V4X) across the recovery switching device Q3X (or Q4X) can substantially reach zero, upon the resonance current ILX reaching the threshold current It, similarly to Embodiment 3. (See FIG. 11.) As a result, the overall duration of the mode I (or III) is shortened while the switching loss at the turn-on of the recovery switching device Q3X (or Q4X) is sufficiently suppressed. (See ΔT shown in FIG. 11.)

In Embodiments 3-5 of the invention, the combinations of the unsaturated inductors LX and LY and the saturable inductors LsX and LsY are used as the recovery inductors. The auxiliary inductor La includes the common core shared with the saturable inductors LsX and LsY. Alternatively, an inductor which has a partially saturable core similar to that of the recovery inductors LpX and LpY according to Embodiment 1 of the invention may be used as a recovery inductor. In that case, the core doubles as the core of the auxiliary inductor.

The above-described disclosure of the invention in terms of the presently preferred embodiments is not to be interpreted as intended for limiting. Various alterations and modifications will no doubt become apparent to those skilled in the art to which the invention pertains, after having read the disclosure. As a corollary to that, such alterations and modifications apparently fall within the true spirit and scope of the invention. Furthermore, it is to be understood that the appended claims be intended as covering the alterations and modifications.

The invention relates to the driver of a capacitive load such as a PDP, and as described above, reduces the inductance of the recovery inductor in response to the current. As is clear from this, the invention has industrial applicability.

1. A capacitive load driver comprising:
a pulse generating section which converts a DC voltage into voltage pulses and which applies said voltage pulses to a capacitive load; and
a power recovery section including:
a recovery capacitor which has a capacitance larger than said capacitive load has and across which a substantially constant voltage is maintained;
a recovery inductor which resonates with said capacitive load and which has an inductance when passing a current substantially equal to zero, at least twice as high as the inductance when passing a current substantially equal to a predetermined threshold value; and
a recovery switching device connecting said recovery capacitor to or separating it from said capacitive load and said recovery inductor, thereby passing or interrupting the current caused by the resonance between said capacitive load and said recovery inductor.

2. The capacitive load driver according to claim 1 wherein said recovery switching device is maintained in the ON state during one of the pulse rise and fall periods of said voltage pulse.

3. The capacitive load driver according to claim 1 wherein said pulse generating section includes two main switching devices connected in series, whose node is connected to said capacitive load and said recovery inductor.

4. The capacitive load driver according to claim 1 wherein said recovery inductor includes a partially saturable inductor having a partially saturable core.

5. The capacitive load driver according to claim 1 wherein said recovery inductor includes an unsaturated inductor and a saturable inductor.

6. The capacitive load driver according to claim 1 wherein said power recovery section further comprises:
an auxiliary inductor magnetically coupled to said recovery inductor; and
a current control section controlling a current flowing through said auxiliary inductor.

7. The capacitive load driver according to claim 6 wherein said current control section includes a variable current source connected to said auxiliary inductor.

8. The capacitive load driver according to claim 6 wherein
said current control section includes a protection diode connecting the node between said recovery inductor and said recovery switching device to one of a power supply terminal and a ground terminal; and
said auxiliary inductor is connected in series to said protection diode.

9. The capacitive load driver according to claim 6 wherein
said current control section (4C) includes an impedance element connecting the output terminal of said pulse generating section to said recovery capacitor; and
said auxiliary inductor is connected to said impedance element in series.

10. A plasma display comprising:
a plasma display panel (PDP) comprising discharge cells emitting light owing to electric discharge in gas filling said cells, and a plurality of electrodes for applying voltage pulses to said discharge cells;
a power supply section for converting an AC voltage from an external power supply to a DC voltage; and
a PDP driver comprising:
a pulse generating section which converts said DC voltage to said voltage pulses and which applies said voltage pulses to said electrodes of said PDP; and
a power recovery section including
a recovery capacitor which has a capacitance larger than the capacitance between said electrodes of said PDP and across which a substantially constant voltage is maintained;
a recovery inductor which resonates with the capacitance between said electrodes of said PDP and which has an inductance when passing a current substantially equal to zero, at least twice as high as the inductance when passing a current substantially equal to a predetermined threshold value; and
a recovery switching device connecting said recovery capacitor to or separating it from said electrodes of said PDP and said recovery inductor, thereby passing or interrupting the current caused by the resonance between the capacitance of said electrodes and said recovery inductor.
